(19) United States
(12) Patent Application Publication
(10) Pub. No.: US 2005/0132292 A1
(43) Pub. Date: Jun. 16, 2005

(54) Electronic device

(76) Inventor: Chen-Ming Nien, Taipei County (TW)

Correspondence Address: BIRCH STEWART KOLASCH & BIRCH, PO BOX 747, FALLS CHURCH, VA, 22040-0747, US

(21) Appl. No.: 10/732,361

(22) Filed: Dec. 11, 2003

(51) Int. Cl. G11B 27/00; G06F 3/00

(52) U.S. Cl. 715/718; 715/864; 715/778; 715/810; 715/846; 715/849; 715/851; 715/852; 715/827; 715/835; 715/836; 715/837; 715/838; 715/839; 715/840

(57) ABSTRACT

An electronic device. A first operating mode (mobile phone) and a second operating mode (PDA) are provided by the electronic device. The electronic device has a host and a case. The host is provided with a first index portion. The case is disposed on the host for moving between a first position and a second position. When the case moves to the first position, the electronic device provides the first operating mode and partially covers the first index portion. When the case moves to the second position, the electronic device provides the second operating mode.

### BACKGROUND OF THE INVENTION

1. Field of the Invention

The present invention relates to an electronic device, and in particular to an electronic device providing switchable operating modes.

2. Description of the Related Art

Electronic products, such as mobile phone and Personal Digital AssistantS (PDAs) have become indispensable to many. Although originally intended for voice communication, mobile phones now provide a variety of functions including internet access, email, text messaging, and the like. Additionally, “smart phones” combine the features of a conventional mobile phone and a PDA. The PDA includes a touch screen and a stylus. Data are input to the PDA by the stylus via the touch screen, while data are typically input to a mobile phone via keypad. Hence, when combining a mobile phone with a PDA, there is a need to provide an interface that integrates the functions thereof.

In FIG. 1, a conventional smart phone P1 has a monitor 11, a plurality of keys 12, a receiver 13, a microphone 14 and an antenna 15. The smart phone P1 has a monitor 11 larger than a typical mobile phone monitor, and all functions of the smart phone P1 are directly controlled by the keys 12.

The smart phone P1, however, does not provide a stylus or other implements to input data, hence the smart phone must be controlled entirely by the keys 12. Inputting data by the keys 12, may be considered inconvenient or time-consuming, particularly when performing a search function.

In FIG. 2, a smart phone P2 has a touch screen 21, a function key 22, a receiver 23, a microphone 24, an antenna 25, a cover 26, a main body 27 and a stylus 28. The smart phone P2 described herein provides a stylus 28 for inputting data to the PDA component and controlling the mobile phone by tapping the touch screen 21. However, no keys for dialing are provided on the smart phone P2, and may be considered more inconvenient than a conventional mobile phone, particularly when dialing.

In FIGS. 3a and 3b, a smart phone P3 has a touching screen 31, a plurality of function keys 32, a receiver 33, a microphone 34, an antenna 35, a cover 36, a main body 37 and a stylus 38. When the cover 36 is flipped open, the smart phone P3 functions as a PDA. When the cover 36 is flipped closed, the smart phone P3 functions as a mobile phone.

When the cover 36 is stylus, however, the cover 36 is easily flipped back to its original position relative to the main body 37 when acted on by a force. Additionally, it is inconvenient for the user to press the function keys 32 when the cover 36 is open.

Moreover, when opening the cover 36 abnormally or abruptly, cracks are easily generated on the cover 36, especially in the regions near a hinge (not shown), potentially causing the cover 36 to become unhinged the main body 37.

### SUMMARY OF THE INVENTION

Accordingly, an object of the invention is to provide an electronic device with a first operating mode (mobile phone) and a second operating mode (PDA), switchable therebetween by a movable case.

The invention provides an electronic device having a host and a case. The host is provided with a first index portion. The case is disposed on the host and movable between a first position and a second position. When the case moves to the first position, the electronic device is in the first operating mode and partially covering the first index portion. When the case moves to the second position, the electronic device is in the second operating mode. The first operating mode (mobile phone) and the second operating mode (PDA) of the electronic device can be operated simultaneously, preventing cracks or damage to the host or case.

A detailed description is given in the following embodiments with reference to the accompanying drawings.

### BRIEF DESCRIPTION OF THE DRAWINGS

The present invention is more fully understood by reading the subsequent detailed description and examples with references made to the accompanying drawings, wherein:

FIG. 1 is a plane view of a first conventional mobile phone (P1);

FIG. 2 is a perspective view of a second conventional mobile phone (P2);

FIG. 3a is a perspective view of a third conventional mobile phone (P3);

FIG. 3b is a perspective view of the mobile phone (P3) FIG. 3a, wherein the mobile phone (P3) is controlled by a stylus (38);

FIG. 4a is a perspective view of an electronic device (E1) according to a first embodiment of the present invention, wherein the electronic device (E1) has a host (45) and a case (46);

FIG. 4b is a perspective view of the mobile phone (P3) of FIG. 4a, wherein the electronic device (E1) is controlled by a stylus (47);

FIG. 5 is a top view of the mobile phone (P3) of FIG. 4a;

FIG. 6 is a side view of the mobile phone (P3) of FIG. 4b, wherein the stylus (47) is disposed on the host (45);

FIG. 7 is a rear view of the mobile phone (P3) of FIG. 6; and

FIG. 8 is a perspective view of an electronic device (E2) according to a second embodiment of the present invention, wherein the electronic device (E2) has a host (85), a case (86) and a stylus (87).

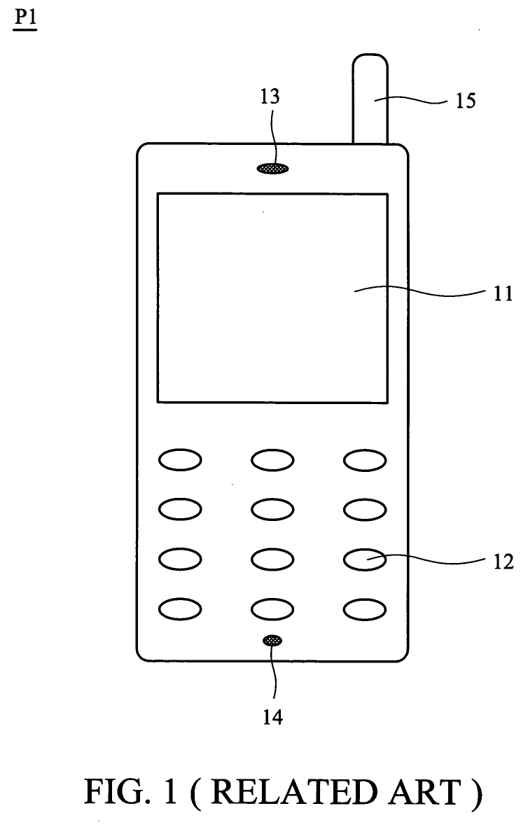

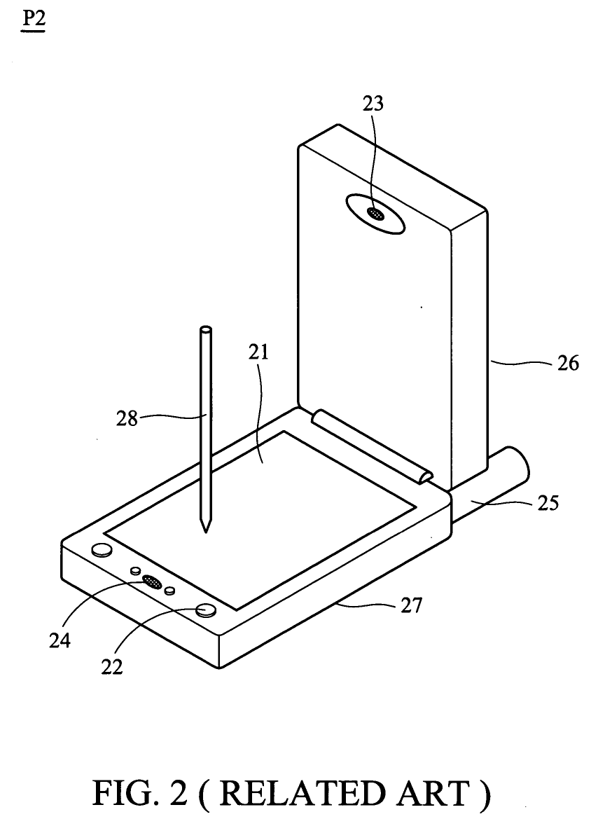

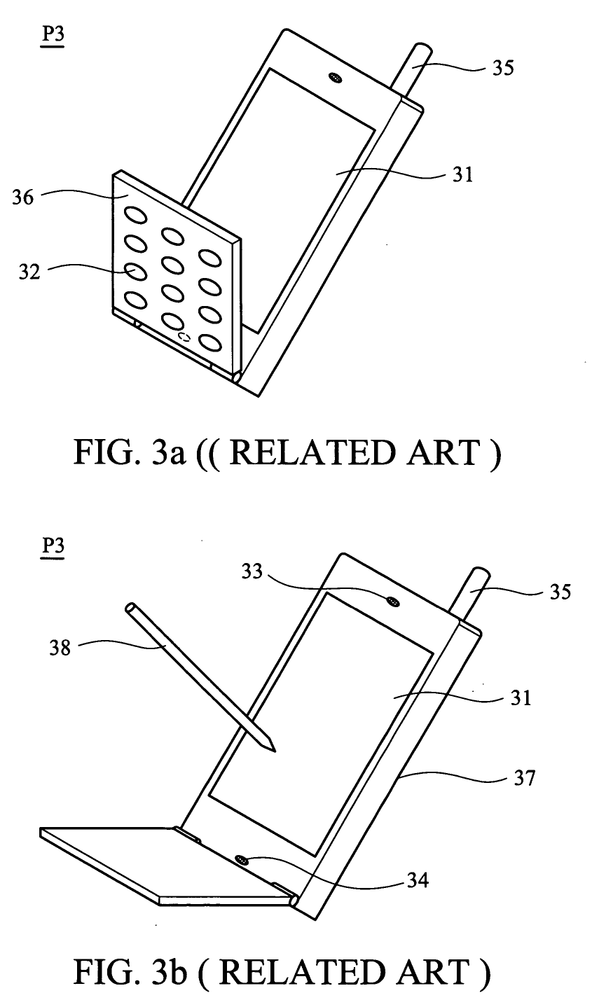

### DETAILED DESCRIPTION OF THE INVENTION

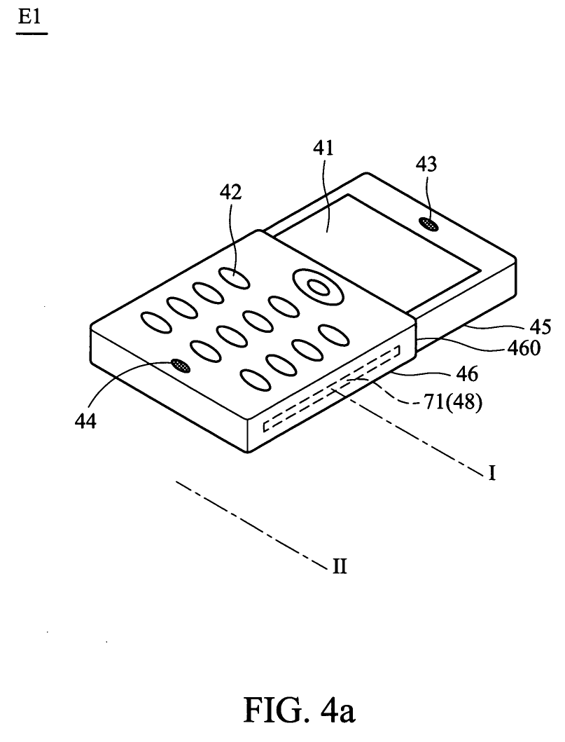

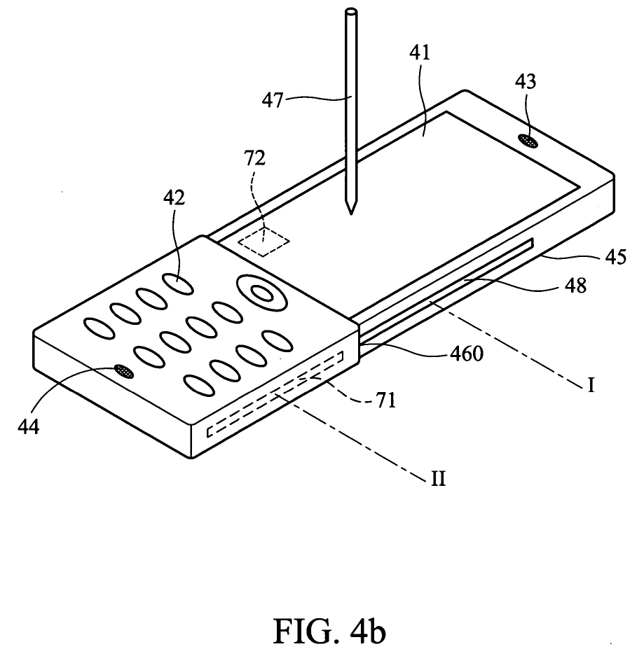

Referring FIGS. 4a and 4b, in a first embodiment of the invention, an electronic device E1 has a host 45, a case 46 and a stylus 47. The host 45 provides a first index portion 41, and the case 46 is disposed on the host 45 and movable along the longitudinal direction of the host 45. The stylus 47 inputs data and controls the host 45 by tapping the first index portion 41.

The host 45 is a main body of the electronic device E1 and provided with a processing unit (not shown). The first index portion 41 is a rectangular touching screen disposed on the upper surface of the host 45 and electrically connected to the processing unit of the host 45. A receiver 43 is disposed on the host 45 and electrically connected to the processing unit of the host 45. A first guide portion 48 is formed on the sidewall of the host 45 and/or electrically connected to the processing unit of the host 45. In this embodiment, the first guide portion 48 is a longitudinal slot formed on the sidewall of the host 45.

The case 46 is hollow and provided with an opening 460. A plurality of second index portions 42 and a microphone 44 are disposed on an outer surface of the case 46 and electrically connected to the processing unit of the host 45, and a second guide portion 71 is formed on an inner surface of the case 46. In this embodiment, the second guide portion 71 is a rail, and the second index portions 42 are function keys.

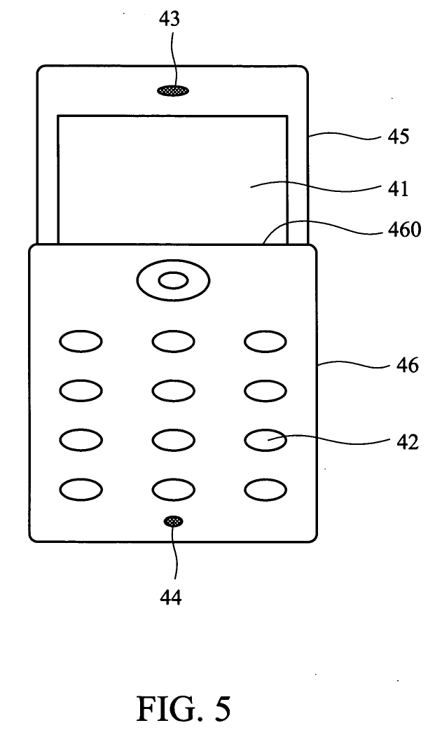

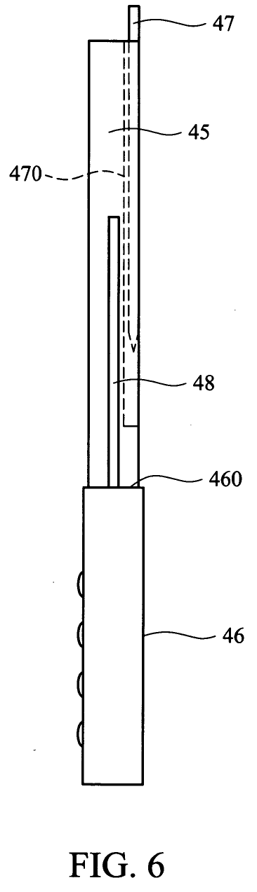

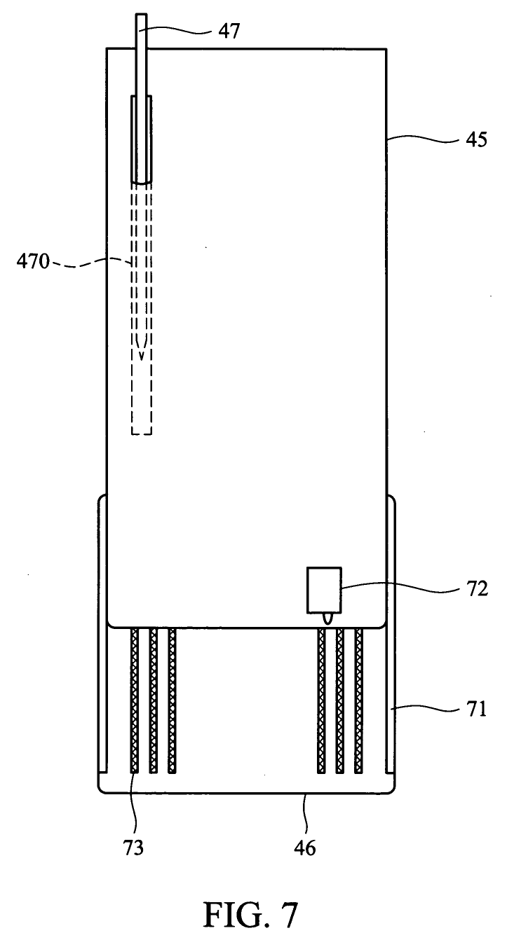

Referring also to FIGS. 5, 6 and 7, a front view of FIG. 5, a side view of FIG. 6 and a rear view of FIG. 7 of the electronic device E1 clearly illustrate how the case 46 and the host 45 are assembled.

In FIG. 7, a detecting element 72, such as a sensor, is disposed on the host 45 with respect to the case 46 and electrically connected to a processing unit of the host 45. A receiver 470 is an opening formed on the host 45. A plurality of lead wires 73, disposed on the inner surface of the case 46, connect the second index portion 42 and the microphone 44 to the processing unit of the host 45, such that signals or commands transmitted from the second index portion 42 and the microphone 44 are transmitted to the processing unit of the host 45 through the lead wires 73. A holding device (not shown), disposed in the host 45 and connected to the processing unit, clamps or releases the stylus 47 when the stylus 47 is placed in the receiver 470. Thus, the stylus 47 disposed in the receiver 470 controls the first index portion 41 of the host 45, and the detecting element 72 detects the position of the case 46 and transmits signals to the processing unit of the host 45 when the case 46 moves between the first position I and the second position II.

When the case 46 and the host 45 are assembled, the host 45 is fitted into the opening 460 of the case 46 and partially covered by the case 46, and the first guide portion 48 of the host 45 is then engaged with the second guide portion 71 of the case 46. The position of the case 46 disposed on the host 45 in FIG. 4a moves to a first position I, i.e., the case 46 is kept at an upper limit position by the limitation between the first guide portion 48 and the second guide portion 71 which are engaged. The position of the case 46 disposed on the host 45 in FIG. 4b moves to a first position II, i.e., the case 46 is kept at a lower limit position by the limitation between the first guide portion 48 and the second guide portion 71 which are engaged.

When the first index portion 41 of the host 45 in FIG. 4a is partially covered by the case 46, i.e., when the housing 46 moves to the first position I, the electronic device E1 functions in a first operating mode (mobile phone). Thus, data is input by pressing the second index portions 42 and the result is output from the first index portion 41.

When the first index portion 41 of the host 45 in FIG. 4b (second position II) is not covered by the hosing 46 (fully open), the detecting element 72 transmits a signal to the processing unit of the host 45 to directing the electronic device E1 to function as PDA and control the holding device to release the stylus 47. That is to say, the electronic device E1 functions in a second operating mode (PDA) and the stylus 47 is removed from the receiver 470 when the case 46 moves to the first position II.

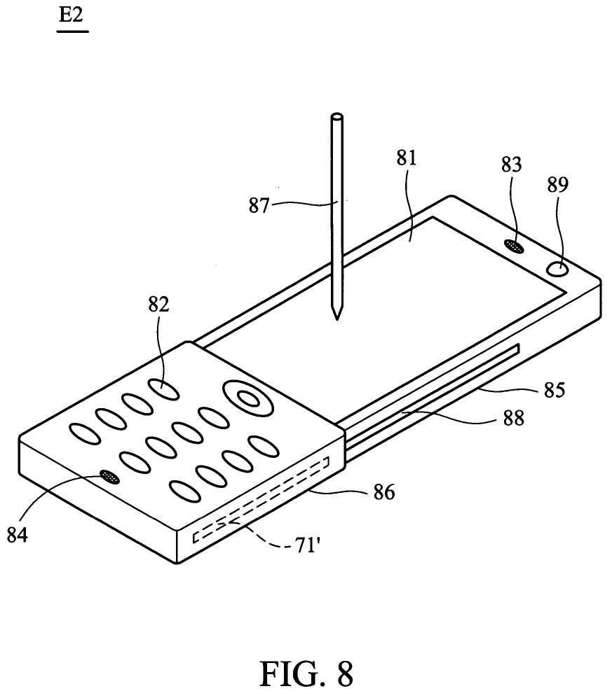

Referring to FIG. 8, in a second embodiment of the invention, an electronic device E2 has a host 85, a case 86 and a stylus 87. The host 85 is provided with a first index portion 81, a receiver 870 and a processing unit (not shown). The case 86 is disposed on the host 85 for moving along the longitudinal direction of the host 85. The stylus 87 inputs data and commands to the host 85 by tapping the first index portion 81.

A first guide portion 88 is formed on the sidewall of the host 85 and electrically connected to the processing unit of the host 85. In this embodiment, the first guide portion 88 is a longitudinal slot. A plurality of second index portions 82 and a microphone 84 are disposed on an outer surface of the case 86 and electrically connected to the processing unit of the host 85, and a second guide portion 71′ is formed on an inner surface of the case 8. In this embodiment, the first index portion 81 is a touching screen, the second index portions 82 are function keys, and the second guide portion 71′ is a rail.

The electronic device E2 differs from the electronic device E1 in that a button switch 89 is provided. The button switch 89, disposed on the host 85 and electrically connected to the processing unit of the host 85, controls ejection the stylus 87 when the case 86 moves to the second position II.

When pressing the button switch 89 and moving the case 86 to the second position II, the stylus 87 is stationary even if switch 89 is turned on. Then, the first index portion 81 is controlled manually, and the electronic device E2 functions as a PDA and is controlled by pressing the second index portions 82. When the button switch 89 is not pressed and case 86 is moved to the second position II, the stylus 87 is ejected as mentioned in the first embodiment.

It is noted that the detecting element 72 and the lead wires 73 mentioned in FIG. 7 are also provided in the second embodiment, but not shown in figures.

Thus, in the electronic device E1, for example, the first operating mode I (mobile phone) and the second operating mode II (PDA) of the electronic device E1 are operated simultaneously. Because the case 46 is an element sliding on the host 45, cracks or damage to the host 45 or case 46 is presented. Further, due to the host 45 and the case 46 being kept on the same plane, i.e., the first index portion 41 (touching screen) and the second index portions 42 (function keys) being located on the same plane, control of the first index portion 41 (touching screen) and the second index portions 42 (function keys) is simplified.

While the invention has been described in connection with what is presently considered to be the most practical and preferred embodiment, it is to be understood that the invention is not limited to the disclosed embodiments, but, on the contrary, is intended to accommodate various modifications and equivalent arrangements included within the spirit and scope of the appended claims.

1. An electronic device providing a first operating mode and a second operating mode, comprising:
a host provided with a first index portion; and
a case disposed on the host for moving between a first position with the first operating mode and partially covering the first index portion and a second position with the second operating mode.

2. The electronic device as claimed in claim 1, wherein the host comprises a receiver and a stylus detachably disposed in the receiver for controlling the first index portion.

3. The electronic device as claimed in claim 2, wherein the stylus is removed from the receiver when the case moves to the second position.

4. The electronic device as claimed in claim 3, wherein the host comprises a switch controlling the stylus when the case moves to the second position.

5. The electronic device as claimed in claim 1, wherein the host is provided with a first guide portion and the case is provided with a second guide portion engaged with the first guide portion.

6. The electronic device as claimed in claim 1, wherein the host has a detecting element to detect the position of the case.

7. The electronic device as claimed in claim 6, wherein the detecting element is applied to switch the first index portion.

8. The electronic device as claimed in claim 1 further comprising a second index portion disposed on the case.

9. The electronic device as claimed in claim 8, wherein the case has a plurality of lead wires connecting the second index portion to the host.

10. The electronic device as claimed in claim 1 further comprising a microphone disposed on the case.

11. The electronic device as claimed in claim 10, wherein the case has a plurality of lead wires connecting the microphone to the host.

12. The electronic device as claimed in claim 1, wherein the first index portion is a touching screen.

13. The electronic device as claimed in claim 8, wherein the second index portion is a key.

14. The electronic device as claimed in claim 6, wherein the detecting element is a sensor.

15. The electronic device as claimed in claim 5, wherein the first guide portion is a slot and the second guide portion is a rail.

16. The electronic device as claimed in claim 1, wherein the first operating mode is a mobile phone.

17. The electronic device as claimed in claim 1, wherein the second mode is a PDA.
